(19) United States
(12) Patent Application Publication
(10) Pub. No.: US 2020/0019985 A1
(43) Pub. Date: Jan. 16, 2020

(54) FRAUD DISCOVERY IN A DIGITAL ADVERTISING ECOSYSTEM

(71) Applicant: Cognant LLC, Mountain View, CA (US)

(72) Inventors: Heng Wang, San Jose, CA (US); Neal Nakagawa, San Jose, CA (US); Arun Kejariwal, Fremont, CA (US); James Koh, Mountain View, CA (US); Owen S. Vallis, Santa Clara, CA (US)

(21) Appl. No.: 16/505,375

(22) Filed: Jul. 8, 2019

Related U.S. Application Data
(60) Provisional application No. 62/697,603, filed on Jul. 13, 2018.

(51) Int. Cl. G06Q 30/02; G06F 17/18

(52) U.S. Cl. CPC G06Q 30/0248; G06Q 30/0246; G06F 17/18

(57) ABSTRACT

Detecting and managing fraud in an online system is described. An example computer-implemented method can include obtaining a plurality of signals. Each of the signals may be purported to have been generated by a different client device. The method also includes calculating a summary value for the obtained signals that indicates a measure of similarity between the obtained signals and an expected distribution of signals. The method also includes determining that the summary value represents a statistically significant deviation of the obtained signals from the expected distribution of signals. The method also includes labeling the obtained signals as fraudulently generated based on the statistically significant deviation.

### CROSS-REFERENCE TO RELATED APPLICATIONS

This application claims the benefit of U.S. Provisional Patent Application No. 62/697,603, filed Jul. 13, 2018, the entire contents of which are incorporated by reference herein.

### BACKGROUND

The present disclosure relates generally to fraud detection and, in certain examples, to systems and methods for detecting and managing fraud associated with online marketing systems.

Mobile application owners aim to attract new users and to engage those users in their applications. One way to track new users is to count the number of unique devices that install a given application. One way to track user engagement is to count the number of clicks that originate from a given device or group of devices. When a new install or click can be attributed to an advertiser, publisher, or marketing partner, the mobile application owner generally pays the advertiser, publisher, or marketing partner. This is known as pay-per-click (PPC) advertising. Sometimes a fraudster fabricates installs and clicks. If gone unnoticed, the fraud can cause the mobile application owner to lose money by paying for fraudulent installs and clicks.

### DESCRIPTION OF THE DRAWINGS

FIG. 1 is a schematic diagram of an example fraud detection system.

FIG. 2 is a schematic data flow diagram of source data in an example fraud detection system.

FIG. 3 is a block diagram illustrating an overview of an example fraud detection system that includes both real-time and batched fraud detection.

FIG. 4 is an example representation of a device identification (ID) character sequence.

FIG. 5 is a table illustrating character probabilities for an example expected distribution of signals of a group of device IDs.

FIG. 6 is a block diagram illustrating an example fraud detection system incorporating a data fitness test for a determined cohort of received data signals.

FIG. 7 illustrates an example computer-implemented method of detecting and managing fraud in an online system.

### DETAILED DESCRIPTION

The subject matter of this disclosure generally relates to detecting and managing fraud related to new user acquisition and engagement with software applications (e.g., mobile applications). A fraud-detection system detects when received data deviates from an expected distribution of data without requiring an administrator to have specific domain knowledge of the fraud being committed. New users of software applications are often acquired through online marketing campaigns where a publisher presents content to users on their client devices. The users can interact with the content and can take certain actions (e.g., install a software application) in response to the content. When a user installs the software application, that user may be considered a new user. When such user action is attributed to a specific publisher, the publisher can receive compensation. This can incentivize publishers to engage in fraudulent activity in an effort to obtain the attribution and compensation.

Two examples of costly online advertising fraud are install fraud and click fraud. Install fraud can occur when a fraudster fabricates multiple fake application installs on a single device by altering the device identification (ID) and using proxy servers or virtual private networks (VPNs) for the fake installs. A VPN allows the fraudster to replace their device's IP address with that of the VPN provider. This allows the fraudster to install an application multiple times on a single device and make it appear as if the application is being installed on multiple devices in multiple different physical locations. Click fraud can occur when phony clicks (e.g., mouse clicks, finger taps, or similar user inputs) are generated for client devices, thus making it look like a user is engaged when she is not. Paying for these fraudulent installs and clicks can be costly.

To detect fraud perpetrated in the above manner as well as in ways not discussed above, the following fraud detection methods and systems are provided. A fraud detection module may perform both real-time and batched fraud detection to identify fraud signals via analysis of source data. Source data may include any information that is received from a user device, such as the device ID, installation time-stamps, click time-stamps, actions performed within an application, or any other suitable information. The fraud detection module may identify signals obtained from the source data. For example, the obtained signals may be a group of device IDs purported to be associated with unique user devices. The detection module may perform two types of tests on the obtained signals: a real-time invalid character test, and a batched fraud-detector test. The real-time invalid character test may examine each obtained signal (e.g., each device ID) to determine if any characters are invalid. An invalid character may indicate a fraudulently generated signal.

In some embodiments, the batched fraud detector test examines batches of signals through statistical analysis to determine if the entire batch is fraudulent. This disclosure refers to these batches of signals as groups of signals, cohorts of signals, and plurality of signals. The batched fraud detector test includes generating an expected distribution of signals. Continuing the device ID example, the expected distribution of signals may be an expected distribution of device ID characters. The obtained signals from the source data may be compared with one or more statistical tests to the expected distribution of signals. From this comparison, a summary value for the obtained signals may be calculated. The summary value may indicate a measure of similarity between the obtained signals and the expected distribution of signals. A summary value representing a statistically significant deviation of the obtained signals from the expected distribution of signals may indicate that the obtained signals were fraudulently generated. If the calculated summary value represents a statistically significant deviation of the obtained signals from the expected distribution of signals, the fraud detection module may label or otherwise identify the obtained signals as fraudulently generated.

One or more appropriate corrective/responsive actions can be taken once a signal or group of signals have been identified as fraudulent. For example, if either test indicates a fraudulent signal or group of signals, the fraud detection module may (1) label the signal or group of signals as fraudulently generated, (2) create a fraud report, and/or (3) update a fraud database with the newly identified fraud information.

Sometimes the fraudulently generated device IDs do not conform to what a device ID would normally look like. In some embodiments, a legitimately generated device ID has a predefined number of characters (e.g., 32 total characters) randomly selected from a predefined set of characters (e.g., hexadecimal, or 0-9 and a-f). For the purposes of explaining the invention, this disclosure uses device IDs that have 32 hexadecimal characters that are generated using a uniform random process, although device IDs can contain any suitable collection of numbers, letters, characters, etc. and be of any appropriate length. Each character may be independent and identically distributed. Thus, for a legitimately generated device ID in the present illustration, there is an equal probability that a given character will be any one of the hexadecimal characters (i.e., 0, 1, 2, 3, 4, 5, 6, 7, 8, 9, a, b, c, d, e, f). It follows that for a group of legitimately generated device IDs (e.g., from many different users who have installed the application on their device), the distribution of characters across the 32 positions in the device ID string will be approximately uniform. If a fraudster attempts to fabricate device IDs but does not do so using a uniform random process, the distribution of characters in the group of fabricated device IDs may not be uniform. This is one way the system can determine if a group of device IDs has been fraudulently generated. If their distribution does not “fit” an expected distribution, the system may label that group as fraudulently generated. The system may use any suitable algorithm to make this determination. One example test is a Chi-Square Goodness of Fit test.

The fraud detection system may detect click fraud using a process similar to detecting install fraud. In the case of click fraud, the source data may be click streams for one or more client devices. The click streams may have time stamps indicating when each click occurred. An expected distribution of time stamps may be determined by the fraud detection system by, for example, examining past distributions of time stamps that have been determined to be legitimate. The received time stamps may then be compared to the expected distribution of time stamps and a summary value may be calculated. If the summary value indicates that the received time stamps deviate from the expected distribution of time stamps by a threshold amount, the received click stream may be labeled as fraudulently generated. The algorithm used to calculate the summary value may be any suitable algorithm, including a Chi-Square Goodness of Fit test or a Kolmogorov-Smirnov test.

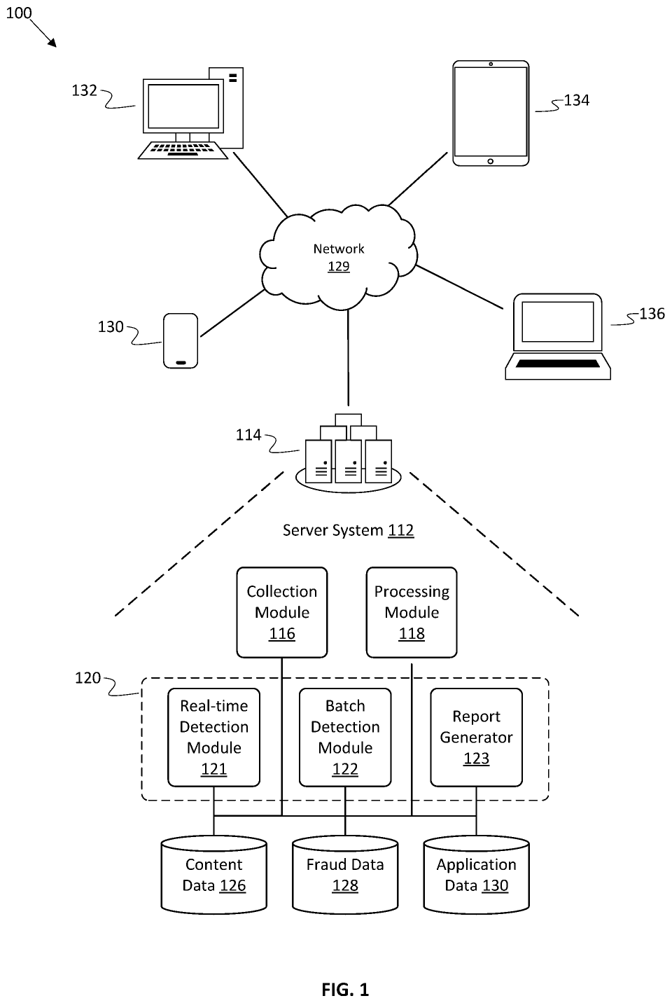

FIG. 1 illustrates an example fraud detection system 100 for detecting and managing fraud in online marketing systems. A server system 112 provides functionality for collecting and processing source data from client devices 130-136. The server system 112 includes software components and databases that can be deployed at one or more data centers 114 in one or more geographic locations, for example. In certain instances, the server system 112 is, includes, or utilizes a content delivery network (CDN). The server system 112 software components can include a collection module 116, a processing module 118, a fraud detection module 120 which includes a real-time detection module 121, a batch detection module 122, and a report generator 123. The software components can include subcomponents that can execute on the same or on different individual data processing apparatus. The server system 112 databases can include a content data 126 database, a fraud data 128 database, an application data 130 database, and any suitable number of other databases that are not illustrated in FIG. 1, such as a click database and a blacklist database. Alternatively, the blacklist database may be included in the fraud data 128 database. The databases can reside in one or more physical storage systems. The software components and data will be further described below.

An application, such as a web-based application, can be provided as an end-user application to allow users to interact with the server system 112. The client application or components thereof can be accessed through a network 129 (e.g., the Internet) by users of client devices, such as a smart phone 130, a personal computer 132, a tablet computer 134, and a laptop computer 136. Other client devices are possible. Additionally or alternatively, software components for the system 100 (e.g., the collection module 116, the processing module 118, the real-time detection module 121, the batch detection module 122, the report generator 123) or any portions thereof can reside on or be used to perform operations on one or more client devices.

The fraud detection system 100 includes the collection module 116, the processing module 118, the real-time detection module 121, the batch detection module 122, and the report generator 123 as being able to communicate with the content data 126 database, the fraud data 128 database, and the application data 130 database. The content data 126 database may include digital content that can be presented on the client devices. The digital content can be or include, for example, images, videos, audio, computer games, text, messages, offers, and any combination thereof. The application data 130 database generally includes information related to user devices and to actions users have taken with regard to a specific application. Examples include downloads of the application, clicks generated by users who interact with content presented on client devices, in-app purchases, user engagement, and the like. Such information can also include, for example, a device identifier or device ID, a content identifier (e.g., an identification of a specific video or image), a content type (e.g., image, video, and/or audio), a timestamp (e.g., date and time), an IP address, a device geographical location (e.g., city, state, and/or country), and any combination thereof. For example, when a user clicks an item of content presented on a client device, information related to the click (e.g., the device identifier, the content identifier, the timestamp, etc.) can be received by and stored in the application data 130 database. The fraud data 128 database generally includes a listing of client devices, publishers, and other sources that have been previously associated with fraudulent activity. Such information can include, for example, a device identifier, a publisher identifier, a date or time of previous fraudulent activity, a device geographical location, an IP address, and any combination thereof.

The digital content (e.g., from the content data 126 database) can be presented on the client devices using a plurality of publishers. Any suitable number of publishers and publisher modules are possible. Each publisher can be or include, for example, a website and/or a software application configured to present the content. When an item of content is presented on a client device, the user can interact with the content in multiple ways. For example, the user can view the content, select or click one or more portions of the content, play a game associated with the content, and/or take an action associated with the content. In certain instances, the action can be or include, for example, watching a video, viewing one or more images, selecting an item (e.g., a link) in the content, playing a game, visiting a website, downloading additional content, and/or installing a software application. In some instances, the content can offer the user a reward in exchange for taking the action. The reward can be or include, for example, a credit to an account in exchange for viewing an advertisement. Examples of other rewards include a virtual item or object for an online computer game, free content, or a free software application. Other types of rewards are possible.

Additionally or alternatively, the publishers can be rewarded based on actions taken by users in response to the displayed content. For example, when a user clicks or selects an item of content or takes a certain action in response to the content (e.g., downloading an advertised application), the publisher can receive compensation based on the user action.

In some instances, for example, a publisher can receive compensation when it presents an item of content on a client device and a user installs a software application (or takes a different action) in response to the content. The publisher can provide information to the collection module 116 indicating that the content was presented on the client device. Alternatively or additionally, the collection module 116 can receive an indication that the software application was installed. Based on the received information, the collection module 116 can attribute the software application installation to the item of content presented by the publisher. The publisher can receive the compensation based on this attribution.

The collection module 116 may include or otherwise be in communication with an attribution service provider. The attribution service provider may receive information from publishers related to the presentation of content and user actions in response to the content. The attribution service provider may determine, based on the information received, how to attribute the user actions to individual publishers. In some instances, for example, a user can visit or use websites or software applications provided by publishers that present an item of content at different times on the user's client device. When the user takes an action (e.g., installs a software application) in response to the content presentations, the attribution service provider may select one of the publishers to receive the credit or attribution for the action. The selected publisher may be, for example, the publisher that was last to receive a click on the content before the user took the action. The selected publisher can receive compensation from an entity associated with the content or the action.

This scheme in which publishers can receive compensation based on attribution for user actions can result in fraudulent publisher activity. For example, a fraudulent publisher can send incorrect or misleading information to the collection module 116 (or attribution server provider) in an effort to fool the collection module 116 into attributing user action to content presented by the publisher. The fraudulent publisher can, for example, provide information to the collection module 116 indicating that an application was downloaded and installed by multiple client devices when the client devices do not even exist, or when the client devices did not in fact download or install the application. Additionally or alternatively, the fraudulent publisher can provide information to the collection module 116 indicating that the user interacted with the content (e.g., clicked on the content) when such interactions did not occur. Based on this incorrect information, the collection module 116 (or attribution service provider) can erroneously attribute user action (e.g., an application installation) to the fraudulent publisher, which may be rewarded (e.g., paid) for its deceitful activity.

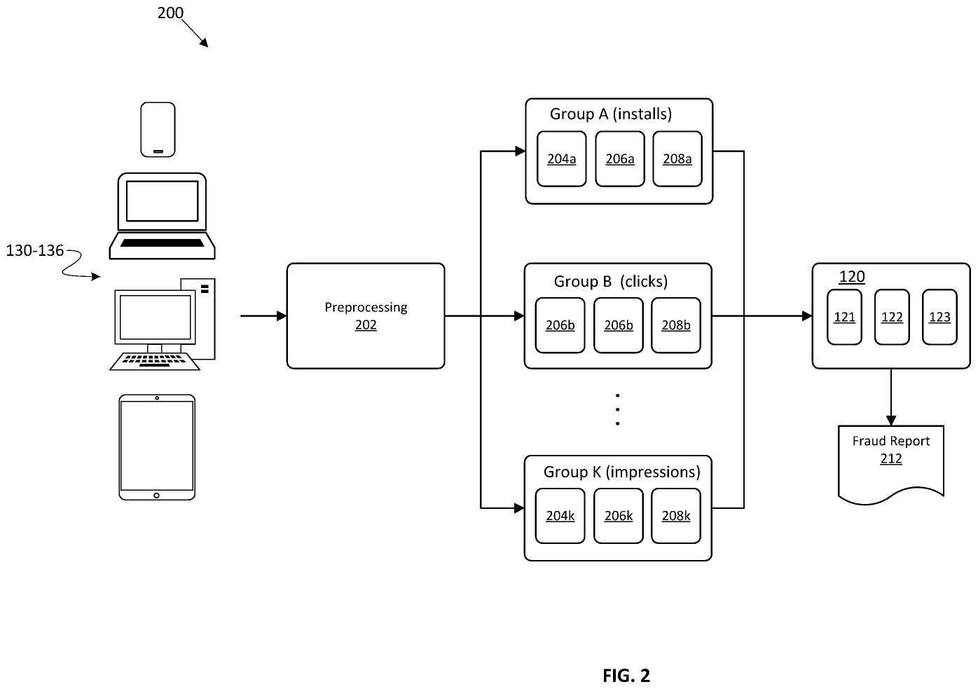

FIG. 2 is a schematic data flow diagram 200 of source data in an example fraud detection system. The temporal anomaly detection system 200 may use dynamic and robust anomaly detection algorithms and modular and extensible framework that uses batch processing to surface abnormal deviations of performance-related metrics. Preprocessing 202 may be performed by processing module 118 or another suitable module to process source data (e.g., installs, clicks, impressions, backend metrics) generated by client devices 130-136. The source data may come in the form of a live data stream, such that data for an event (e.g., install, click, impression) can be received immediately or shortly (e.g., within seconds or minutes) after the event occurs. The source data may also include information about the publishers or content providers that incentivized the event. This information may be used to determine attribution. The preprocessing 202 may ensure that the data is complete and accurate, for example, by cleansing the data to remove any erroneous data or handle any missing or inaccurate data. The preprocessing 202 can also group the data streams into any appropriate number of groups and in any suitable manner, including the following two ways: (1) by metric (e.g., installs, clicks, impressions), and by time (e.g., hourly, daily, weekly). For example, all the installs may be grouped in Group A, the clicks may be grouped in Group B, and the impressions may be grouped in Group K. Each group may be further divided into temporal categories. For example, hourly streams 204a, 204b, . . . 204k, daily streams 206a, 206b, . . . 206k, weekly streams 204a, 204b, . . . 204k, and so on. The various streams are then fed into fraud detection module 120. The fraud detection module 120 then runs one or more tests and determines whether the source data is fraudulent. A fraud report 212 may be generated if any of the source data is determined to be fraudulent.

In general, the data streams may include, for example, install data, click data, impression data, in-app purchase data, or any other suitable data. The data streams may also be grouped by publisher. Thus, all the data that is received as a result of a particular publisher may be grouped together. For example, a publisher may publish 100 blog posts online. Each blog post may have an advertisement to download a particular application. As a result of these advertisements on the 100 blog posts, 5,000 users download the application. The device IDs associated with those 5,000 users may be grouped together. In addition, for each download, the record can include, for example, a timestamp of the download, an IP address, a user agent (e.g., a web browser), a device geographical location, an item of content associated with the download, and/or a publisher associated with the download, among other data.

The data stream may be provided to the fraud detection module 120. The fraud detection module may then perform one or more fraud detection tests on the data stream, such as an invalid character test by the real-time detection module 121 and a Chi-square Goodness of Fit test by the batch detection module 122. In addition, client devices, publishers, and other sources that have been previously associated with click fraud (e.g., during an earlier time period) can be included by the real-time detection module 121 in a blacklist in the fraud data 128 database. Any such sources identified in the blacklist can be considered to be low-reputation sources and/or more likely to be associated with click fraud in the future. In some examples, any install data or click data in the data stream for low-reputation sources can be filtered, flagged, or removed from the data stream. Other data from more reputable sources can be allowed to pass through for further processing.

In some embodiments, the preprocessing 202 may include separating the data between a real-time data stream and a batch data stream. The batch data stream may include a separate batch of data (e.g., of device IDs from installs, clicks, or impressions) for each client device or for each publisher during a previous time period (e.g., a previous hour, day, week, or any portion thereof). For example, the preprocessing 202 may generate a batched data set that includes all the device IDs for the devices that downloaded a particular application eight days ago. The batched data set may be further broken down by publisher. For example, the batched data set may include a batched sub-data set that includes all the device IDs for the devices that downloaded the particular application eight days ago and can be attributed to publisher A.

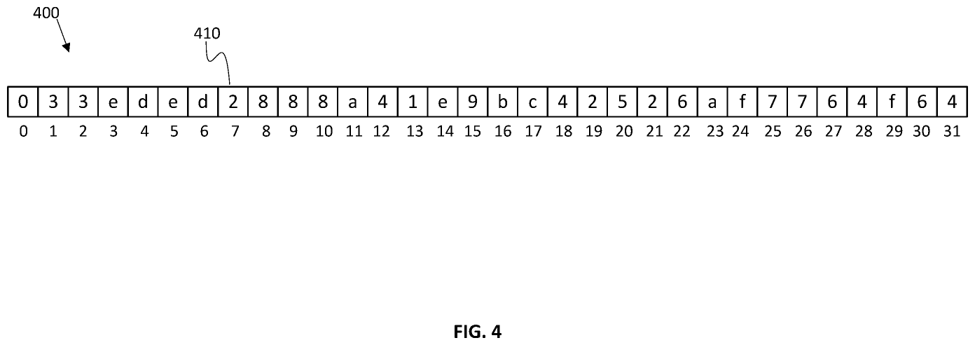

The batched data may be provided to the batch detection module 122, which can use a collection of algorithms to detect fraud in the batched data. In certain instances, for example, the batch detection module 122 can receive a batch of device IDs purporting to be associated with client devices that downloaded the application, select one or more algorithms for processing the data, and use the selected algorithm(s) to detect fraud in the data. The particular algorithms used are discussed in more detail with reference to FIGS. 4-6.

In some embodiments, the fraud detection module 120 may take into account variable factors, such as, for example, seasonality and trend, and/or by making use of dynamic baselines or thresholds to identify statistically significant outliers. In general, a dynamic threshold or baseline can account for variations or changes that occur over time, for example, during an hour, a day, a week, a month, or longer. For example, user interactions with client devices (e.g., clicks and software application installs) can exhibit daily or weekly seasonality in which the interactions can vary in a repetitive manner (e.g., more activity during evenings or on weekends). By using dynamic thresholds that can change over time, the system 200 can account for such variations and achieve more accurate fraud detection with fewer false positives.

Outputs from the fraud detection module 120 may be provided to the report generator 123, which can generate a fraud report 212 of any fraudulent activity. An administrator or user of system 200 may use the report 212 to optimize future content presentations, for example, by blacklisting certain users or publishers who have engaged in fraud. The report can also be used to request or obtain refunds from any publishers that received compensation based on fraudulent activity. The fraud report 212 can be or include an electronic file that is generated or updated on a periodic basis, such as every hour, day, or week. The fraud report 212 can include, for example, an identification of any client devices and/or publishers associated with fraud. In some embodiments, the report generator 123 can update the fraud data 132 database to include a current listing of any client devices and/or publishers that have been associated with fraud as determined by fraud detection module 120. In some instances, the fraudulent activity can be brought to the publisher's attention and/or the publisher may provide a refund of any compensation earned from the fraudulent activity.

Additionally or alternatively, the fraud results can be used to properly attribute user action to content presentations. As mentioned above, when a user takes an action (e.g., installs a software application) in response to a content presentation, a publisher may be selected to receive credit or attribution for the action, and the selected publisher may receive compensation for such attribution. Advantageously, the systems and methods described herein can be used to prevent or correct any attribution due to fraudulent activity. Additionally or alternatively, the systems and methods can be used to determine a proper attribution, by considering only events (e.g., installs, clicks, impressions) that are not fraudulent. In some instances, the systems and methods can be used to revoke or not authorize a prior attribution that was based on fraudulent events, or to withhold any requested compensation based on fraudulent events.

To extract actionable insights from big data, it can be important in some examples to leverage big data technologies, so that there is sufficient support for processing large volumes of data. Examples of big data technologies that can be used with the systems and methods described herein include, but are not limited to, APACHE HIVE and APACHE SPARK. In general, APACHE HIVE is an open source data warehousing infrastructure built on top of HADOOP for providing data summarization, query, and analysis. APACHE HIVE can be used, for example, as part of the processing module 118 to generate and/or process the data stream discussed with reference to FIG. 2. APACHE SPARK is, in general, an open source processing engine built around speed, ease of use, and sophisticated analytics. APACHE SPARK can be leveraged to detect abnormal deviations in a scalable and timely manner. APACHE SPARK can be used, for example, to further process the data stream. In general, the real-time capabilities of the systems and methods described herein can be achieved or implemented using APACHE SPARK or other suitable real-time platforms that are capable of processing large volumes of real-time data.

The systems and methods described herein are generally configured in a modular fashion, so that extending underlying algorithms to new sources and modifying or adding underlying algorithms can be done with minimal effort. This allows the fraud detection systems and methods to be refined and updated, as needed, to keep up with new forms of fraud being created by fraudsters on an ongoing basis. The algorithms in the batch detection module 122 can operate independently from one another, which can allow new algorithms to be implemented and used, without adversely impacting predictive capabilities of existing algorithms.

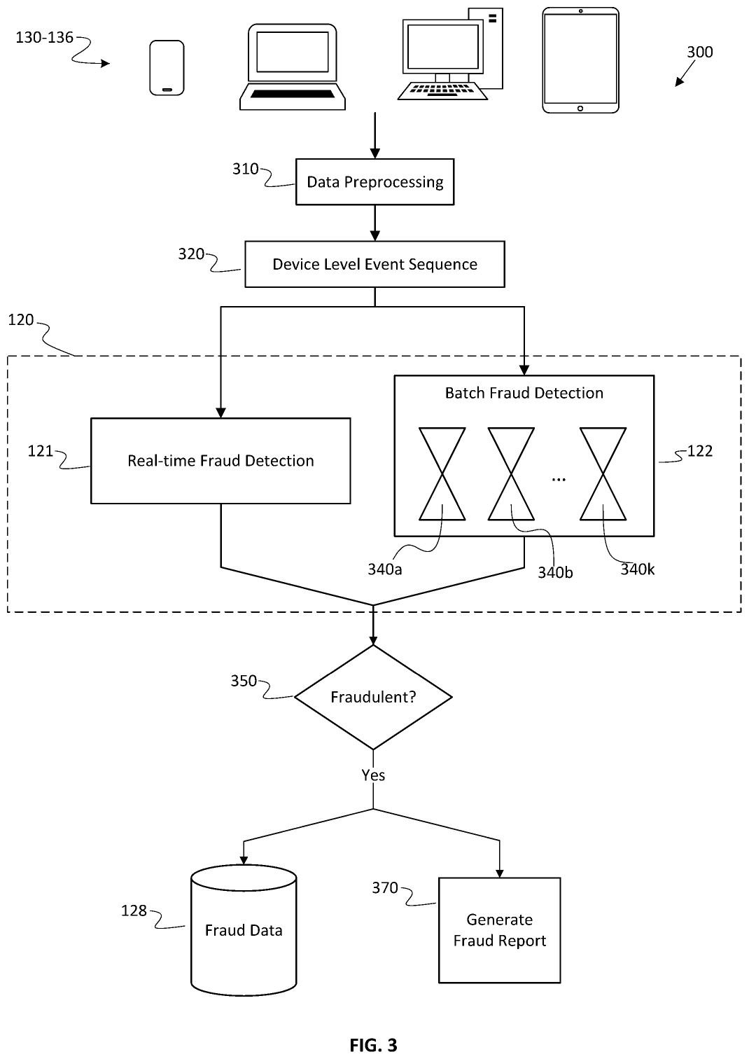

FIG. 3 is a block diagram illustrating an overview of an example fraud detection system 300. This system may operate similarly to that described with reference to FIG. 2. In FIG. 3, the real-time detection module 121 and the batch detection module 122 are separated out and include more detail. In the fraud detection system 300, two branches of fraud detection work together to identify fraudulent events. Data streams are received from user devices 130-136 are preprocessed (e.g., according to the preprocessing described with reference to preprocessing 202), and are grouped according to device-level 320. Grouping according to device-level may mean that information associated with user devices are divided and grouped according to different parameters. For example, the device IDs purporting to be associated with respective user devices that downloaded an application on a specified day may be grouped together. As another example, the device IDs purporting to be associated with respective user devices that downloaded an application due in part to content from a particular publisher may be grouped together.

Once the data has been preprocessed and grouped, it may be fed into fraud detection module 120. The data may be duplicated. One copy of the data may be fed into real-time detection module 121 and another copy of the data may be fed into batch detection module 122. For example, the data may be a set of device IDs. The device IDs may be asserted to be device IDs for user devices that have downloaded a software application as a result of a particular publisher's content. If the device IDs are legitimate, the publisher may receive compensation for incentivizing the installations on the user devices. But if the device IDs are determined to be fraudulent, the device IDs may be labeled as fraudulently generated and may be stored in fraud data 128 database. In addition, the publisher that supplied the fraudulent device IDs may be blacklisted, as discussed above. The real-time detection module 121 may perform any suitable analysis on the data, for example, an invalid character test on each device ID. The invalid character test may involve parsing each character in the device ID and determining if that character is included in an accepted set of characters. For example, if the accepted set of characters is the hexadecimal characters, the invalid character test may determine whether each character is a hexadecimal character. If it is not (e.g., the character is outside of the allowed hexadecimal range or is variant or non-standard character), then the test automatically outputs an indication indicating as much. For example the test for each character may be ( )IsInvalid? and may output a “1” if any character in the device ID is not included in the accepted set of characters, otherwise it may output a “0.”

The batch detection module 122 may include one or more fraud detectors 340a, 340b, . . . 340k. The batched data may be fed into the fraud detectors 340a, 340b, . . . 340k. One of the fraud detectors may use a data fitness test (e.g., a Chi-Square Goodness of Fit test), which will be discussed in more detail with reference to FIGS. 4-6. The batched data may be fed through one, some, or all the fraud detectors 340a, 340b, . . . 340k, such that multiple tests may be performed on the same data. This adds to the robustness of the system, because fraudulent data may go undetected by one fraud detector test, but another fraud detector test may detect the fraudulent data. In some embodiments, each fraud detector test 340a, 340b, . . . 340k may correspond to a different fraud signal. Fraud signals may include any data used to identify fraudulent activity, such as device IDs, time stamps associated with clicks, and the geographic location associated with clicks or installs. As an example, fraud detector test 340a may correspond to device IDs, fraud detector test 340b may correspond to click time stamps, and fraud detector test 340k may correspond to the longitude/latitude associated with an application install. Each fraud detector test 340a, 340b, . . . 340k may output its own determination about whether the inputted data has been fraudulently generated. For example, each fraud detector test 340a, 340b, . . . 340k may output a “1” or a “0”, where “1” indicates that the data has been fraudulently generated, and a “0” indicates that the data has been legitimately generated.

The outputs of the real-time detection module 121 and the batch detection module 122 may be fed into decision block 350, which may examine the real-time data determinations separately from the batched data determinations. For example, the real-time data determinations may include a device ID along with a binary indication of whether the device ID includes an invalid character. If the device ID does include an invalid character, the decision block 350 may determine that the device ID was fraudulently generated. The data may then be labeled as fraudulently generated, stored in the fraud data 128 database, and may be included in a fraud report 212, which is performed at step 370.

Given that the real-time detection module 121 and the batch detection module 122 analyze data derived from a common data stream received from the user devices 130-136, the real-time detection module 121 and the batch detection module 122 can, in some instances, generate duplicate alerts of fraud. In general, the real-time fraud detection module 120 can detect fraud in real-time, while the batch detection module 122 can detect fraud periodically (e.g., daily). The resulting fraud report 212 can include summaries of the real-time and periodic fraud detections. In some instances, the fraud report 212 can utilize or include a fraud scoring system in which sources (e.g., publisher or client device) can be sorted according to fraud severity, where the severity can be evaluated and aggregated over outputs from all detectors.

Advantageously, the ability to perform real-time fraud detection can allow the fraud detection system 300 and/or users thereof to identify a fraud source (e.g., a fraudulent publisher) as soon as possible, such that the source can be shut down quickly and further financial losses due to the fraud can be avoided. Additionally or alternatively, stopping fraud in real-time can help achieve a more accurate attribution of user activity (e.g., application installs) to content presented on client devices.

In various instances, the systems and methods described herein can perform fraud detection at a device level and/or at a publisher level. Such device-level and/or publisher-level granularity can assist with resolving disputes and/or selecting publishers for further content presentations. For example, refund amounts can be calculated fractionally, based on the fraudulent devices. Additionally or alternatively, the anomaly can be more deeply investigated (e.g., at a device level), which can allow publishers to troubleshoot fraud or technical integration issues more efficiently.

Several different actions can be taken, preferably automatically, in response to identified fraud or other anomalies. When a publisher is identified to have engaged in fraudulent activity, for example, the publisher can be added to a blacklist (e.g., a blacklist in the fraud data 128 database) and/or can be prevented from presenting content on client devices in the future. In some instances, the fraudulent activity can be brought to the publisher's attention and/or the publisher may provide a refund of any compensation earned from the fraudulent activity. Alternatively or additionally, the report generator 123 and/or users of the fraud detection system 300 can use the fraud results to make decisions regarding how and where to present content going forward. Publishers who are identified as performing well can be used more in the future, and publishers who are identified as performing poorly or fraudulently can be used less in the future or not at all.

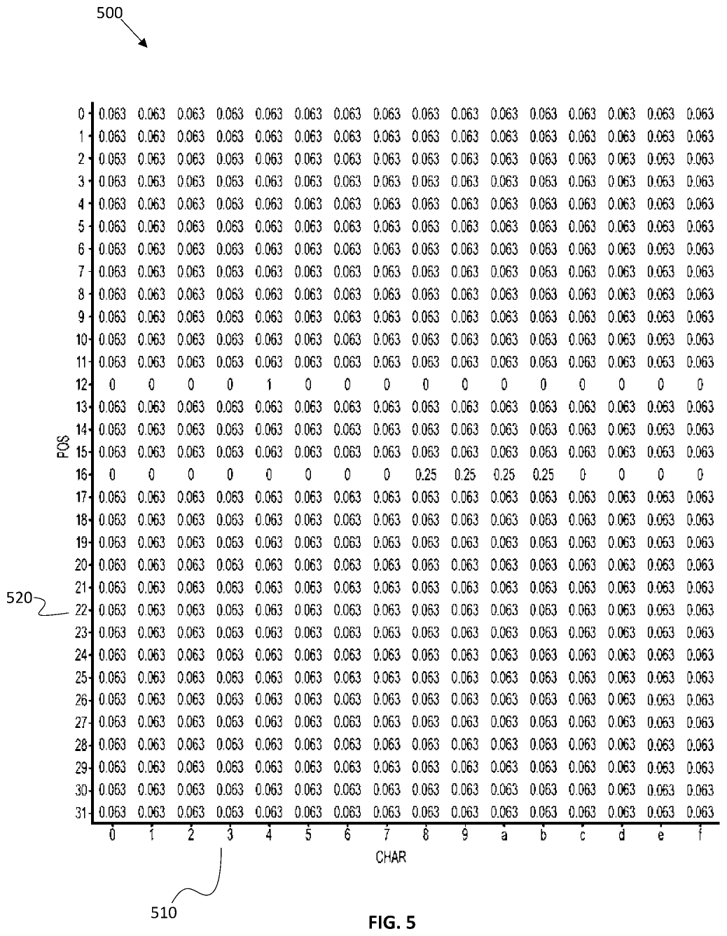

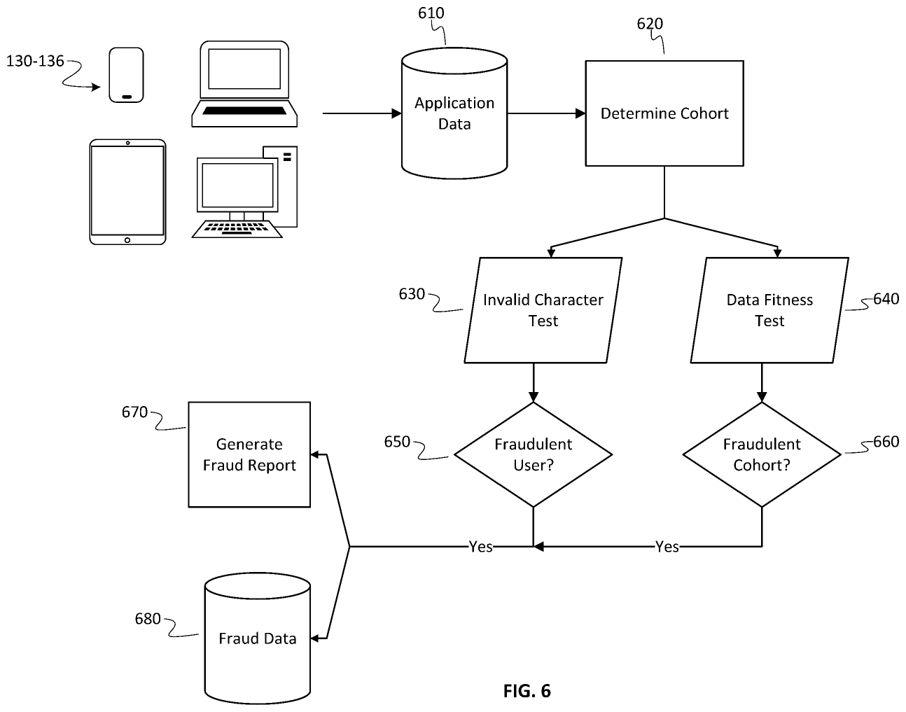

FIG. 4 is an example representation of a device identification (ID) character sequence 400. The device ID character sequence 400 may include several character positions 410, each of which may be populated with a character. The device ID character sequence 400 that has been legitimately generated may adhere to a set of rules stored by the fraud detection module 120. For purposes of illustration and not limitation, the set of rules may include, for example, (1) the characters are randomly generated, (2) the characters must be from the list of hexadecimal characters, (3) the character in position 12 must be 4 (e.g., this may indicate that it is a 4^{th} generation or version 4 of the Universally Unique Identifier (UUID) standard), (4) the character in position 16 must be 8, 9, a, or b, and (5) there must be exactly 32 characters (one for each position from 0-31). Other additional and/or alternative rules are possible, depending on, for example, the numbers, letters, characters, etc. that can be acceptably used in and supported by the device ID, the length of the device ID, and the like. If any of these conditions are not met, the device ID may be labeled as fraudulently generated. Generally, the real-time detection module 121 may be able to handle rules 2 through 5, as discussed herein. For example, the real-time detection module may run a test that counts the number of characters in a device ID. If the device ID has a number of characters that is different from the number of characters provided in a rule (e.g., 32 characters), the real-time detection module 121 may output a result signifying that the device ID has violated that rule. The fraud detection module 120 may then determine that the device ID was fraudulently generated. To verify that the characters in device ID character sequence 400 were randomly generated (i.e., that device ID satisfies rule 1), batch detection module 122 may perform a fraud detector test on a group of device IDs that includes device ID character sequence 400. The fraud detector test may be a data fitness test discussed with reference to FIG. 6, and may more specifically be a Chi-Square Goodness of Fit test. This test is discussed in reference to FIGS. 5 and 6.

FIG. 5 is a table or “heat map” 500 illustrating example character probabilities for an example expected distribution of signals of a group of device IDs. The x-axis lists the sixteen different possible characters 510 in the hexadecimal character list. The y-axis lists the different positions 520 in a device ID: 0 to 31. The cells in table 500 represent character probabilities for the hexadecimal characters 510 at different positions 520 in the device ID that adhere to the rules listed above. Since there are 16 hexadecimal characters, it follows that for any position 520 aside from positions 12 and 16, there is a 1/16 probability of that position having a particular character. For example, the probability that position 0 has the character “a” is 1/16, or 0.0625, which has been rounded to 0.063 in FIG. 5. The same holds for any other character for any other position aside from positions 12 and 16, which have their own rules. Position 12 must have a “4,” so the character probabilities for all characters except “4” are 0, and the probability for character “4” is 1. For position 16, the rules state that position 16 must have an 8, 9, a, or b. Thus, the probability for each of these four characters is 0.25, and the probability for the other characters is 0. Note that the above rules and probabilities are examples only. This disclosure contemplates any set of rules or probabilities. So long as the fraud detection module 120 has been programmed with the rules or with a known distribution, the methods and system discussed herein can detect fraud in a group of data signals. Having a known distribution may be necessary when performing a data fitness test, such as a Chi-Square Goodness of Fit test, as is discussed below.

FIG. 6 is a block diagram illustrating an example fraud detection system incorporating a data fitness test for a determined cohort of received data signals. Source data may be collected from client devices 130-136. The source data may be preprocessed (not illustrated) in the manner discussed above and stored in application database 610. The fraud detection module 120 may then determine a cohort of data signals at step 620. A cohort of data signals may be a plurality of obtained signals (e.g., received device IDs) that is batched as discussed above. A cohort of data signals may include any data used to identify fraudulent activity, such as device IDs, time stamps associated with clicks, and the geographic location associated with clicks or installs. Generally, the cohort of data signals is of a single signal type (e.g., only device IDs in the cohort of data signals). As an example, the determined cohort of data signals may be all the device IDs that correspond to downloads from publisher A from eight days ago. This cohort of signals is then provided to the fraud detection module 120, which performs both an invalid character test 630 and a data fitness test 630. The invalid character test 630 may be any of the invalid character tests discussed herein, for example determining if an unlisted character occupies any position, as well as determining if the device ID contains more or fewer than the accepted number of characters. An extra character may be considered an invalid character. The data fitness test 640 may be any suitable data fitness test, including a Chi-Square Goodness of Fit test, or a Kolmogorov-Smirnov test.

For illustration purposes, a Chi-Square Goodness of Fit test will now be discussed to illustrate how the data fitness test may indicate that a cohort of signals has been fraudulently generated. Chi-Square Goodness of Fit test is a non-parametric test that is used to find out how the observed value of a given phenomenon is significantly different from the expected value. In this case, the Chi-Square Goodness of Fit test may be used to determine how a distribution of received signals (e.g., device IDs) is significantly different from an expected distribution of signals. In Chi-Square Goodness of Fit test, the term “Goodness of Fit” is used to compare the observed sample distribution with the expected probability distribution. The Chi-Square Goodness of Fit test determines how well a theoretical distribution fits the empirical distribution. To perform a Chi-Square Goodness of Fit test, a null hypothesis should be set. The null hypothesis assumes that there is no significant difference between the observed data and the expected distribution of data. An alternative hypothesis may be set, which assumes that there is a significant difference between the observed and the expected distributions of data. To compute the value of Chi-Square Goodness of Fit test, the following formula may be used:

$${X}^{2} = {\sum }_{n = 0}^{31} \frac{{( {O}_{n} - {E}_{n} )}^{2}}{{E}_{n}} ,$$

where X² is the Chi-Squared value, O is the observed value for a given device ID at position n, and E is the expected value for the device ID at position n. The observed and expected values are the frequency counts of each category. For example, for the first position, where n=0, any of the hexadecimal characters has a 0.0625 probability of occupying position 0. If a cohort of 10,000 device IDs are being analyzed, the expected value of any hexadecimal character is 625. In other words, for the character “a,” one would expect the character “a” to appear 625 times in the 0 position of the 10,000 device IDs. The same is true for every position (aside from positions 12 and 16) for every character. The observed value may be more, less, or the same as the expected value, depending on what is observed. If the count of received a's in any given position varies significantly from the expected count of a's for that position, this may weigh in favor of the cohort of signals being fraudulently generated. To make the determination, the batch detection module 122 may calculate X² using all the positions 0-31. Note that the number of positions can be any suitable number—32 positions is merely an example and this disclosure contemplates a Chi-Square Goodness of Fit test for any categorical data.

Once X² is calculated, a summary value p may be calculated through a mathematical formula or a lookup table. The summary value is often referred to in the context of Chi-Square tests as a p-value. The summary value p may then be compared to a threshold value α. If p is greater than α, the fraud detection module 120 may deem the cohort of device IDs to be legitimate. If p is less than α, the fraud detection module 120 may deem the cohort of device IDs to be fraudulently generated. This may be because the summary value p is so small that it is more likely, given the distribution of observed signals, that the observed device IDs were fraudulently generated. In other words, when the summary value p is below a threshold value (e.g., 0.05), it indicates a statistically significant deviation of the distribution of the received signals from the expected distribution of signals. If this is the case, fraud detection module 120 may label the cohort of signals as fraudulently generated, generate a fraud report at 670, and update a fraud database at 680.

The above example Chi-Square Goodness of Fit test is appropriate when the data is categorical. With the case of device IDs, the possible characters that populate the device ID positions are categorical (i.e., there are sixteen different categories: 0-9 and a-f). Thus, a Chi-Square Goodness of Fit test is appropriate. If, however, the data is continuous, different tests may be used, such as the Kolmogorov-Smirnov Goodness of Fit test (KS test). A KS test evaluates an observed data set with an expected probability distribution in a single dimension. A KS test may be used on data that is continuous, for example, a data stream of clicks to install an application over a period of time. The fraud detection system may have an expected distribution of such clicks over a particular time period, such as one day. The fraud detection system may obtain source data that includes a time stamp of each click to install a particular application, as discussed above with reference to FIG. 2. It may then run a KS test of the received time stamp data to determine how closely the received data fits the expected distribution. A summary value is also determined which is a representation of how closely the received data fits the expected distribution. The summary value is generally known as the KS statistic. Similarly to the Chi-Square Goodness of Fit test, the KS test's KS statistic can be used to determine whether the received data was fraudulently generated. If the KS statistic is above a threshold, the fraud detection module 120 may determine that the received data was fraudulently generated, or at least it will output an indication that the received data failed the KS test. In addition to the Chi-Square Goodness of Fit test and the KS test, any other suitable tests may be used, such as the Anderson-Darling test and the Cramer Von Mises test.

In some embodiments, the batch detection module 122 can perform multiple fitness tests 640, depending on the received data signals. As an example, the received data signals may be both device IDs and time stamps of clicks to install a particular application. In this case, the batch detection module 122 may perform both a Chi-Square Goodness of Fit test and a KS test. The fraud detection module 120 may use the output of both of these tests to make a determination on whether the received data was fraudulently generated. In one embodiment, the fraud detection module 120 may weigh the outcome of each test differently depending on several factors, including, for example, the quality of the data and the reliability of each respective test. For example, the output of the Chi-Square Goodness of Fit test may be represented with the variable A, and the output of the KS test may be represented with the variable B. The Chi-Square Goodness of Fit test may be a more reliable test than the KS test and/or may have more reliable data than the data used in the KS test. Therefore, the fraud detection module 120 may weigh A more heavily than B. For example A may receive a weighting of 0.75 and B may receive a weighting of 0.25. The fraud detection module 120 may then perform an analysis of the outcomes of the various tests to determine whether the received data was fraudulently generated. For example, the analysis may involve computing the following formula: F=Ax+By+ . . . Kz, where F is the fraud level, A is the output of test A (e.g., test 340a), B is the output of test B (e.g., test 340b), K is the output of test K (e.g., test 340k), and x, y, . . . z are the different weights assigned to the outputs. If the fraud level F is calculated to be above a threshold level, the fraud detection module 120 may determine that the received data was fraudulently generated. Performing and weighting multiple fitness tests may provide a more robust and reliable fraud detection system that avoids false positive results.

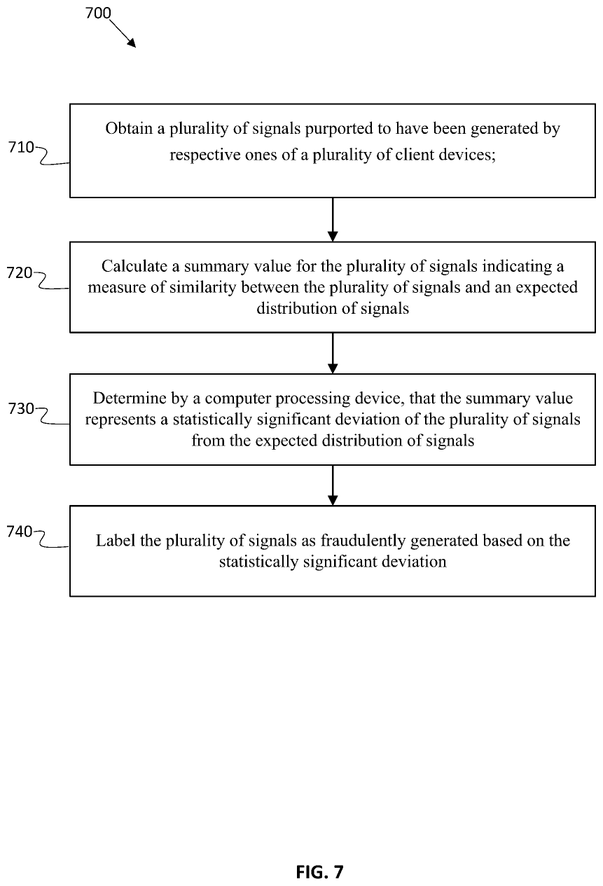

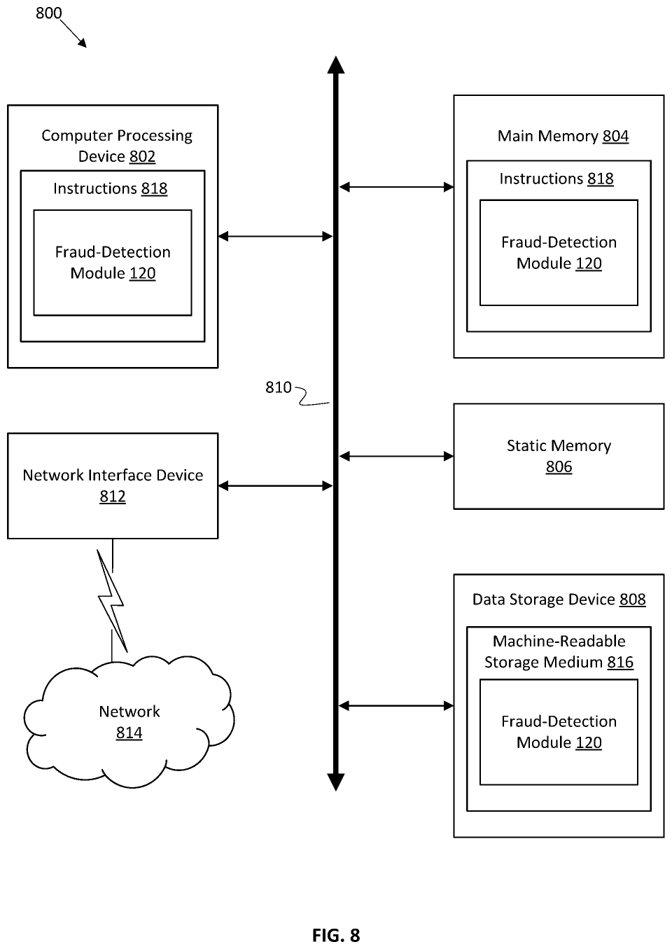

FIG. 7 illustrates an example computer-implemented method 700 of detecting and managing fraud in an online system. Two examples of fraud are click fraud and install fraud, as discussed herein. The method may begin at step 710, where a plurality of signals is obtained. The obtained signals may be preprocessed source data originating from client devices 130-136. Examples of obtained signals include multiple device IDs of client devices that have allegedly installed a software application, grouped by date or by the publisher attributed to the install. At step 720, a summary value is calculated for the obtained signals. The summary value may indicate a measure of similarity between the plurality of signals and an expected distribution of signals. The summary value may be a P-value obtained by performing a Chi-Square Goodness of Fit test or a KS statistic obtained by performing a KS test, or any other value that indicates how well the obtained signals fit the expected distribution of signals. The expected distribution of signals may be known beforehand either from historical data or from one or more rules about the source data. For example, the source data may be device IDs for 10,000 client devices that have installed a software application. The expected distribution of signals may be a count of each character in the 10,000 device IDs. Since the device IDs are randomly generated, it follows that if the obtained device IDs were actually randomly generated, the counts of each of the characters will be substantially even. The expected distribution of signals may reflect such a rule. If the obtained signals deviate significantly from the expected distribution of signals, the summary value may reflect it. At step 730, the fraud detection module 120 may make a determination that the summary value represents a statistically significant deviation of the plurality of signals from the expected distribution of signals. This may occur if the p-value, for example, is less than a threshold value α, which may be 0.05 or any other suitable threshold. At step 740, the plurality of signals may then be labeled or otherwise identified as fraudulently generated based on the statistically significant deviation. This information may be included in a fraud report 212 and may also be stored in a fraud data 128 database.

FIG. 8 is a block diagram of an example computing device 800 that may perform one or more of the operations described herein, in accordance with the present embodiments. The computing device 800 may be connected to other computing devices in a LAN, an intranet, an extranet, and/or the Internet. The computing device 800 may operate in the capacity of a server machine in client-server network environment or in the capacity of a client in a peer-to-peer network environment. The computing device 800 may be provided by a personal computer (PC), a set-top box (STB), a server, a network router, switch or bridge, or any machine capable of executing a set of instructions (sequential or otherwise) that specify actions to be taken by that machine. Further, while only a single computing device 800 is illustrated, the term “computing device” shall also be taken to include any collection of computing devices that individually or jointly execute a set (or multiple sets) of instructions to perform the methods discussed herein.

The example computing device 800 may include a computer processing device (e.g., a general purpose processor, ASIC, etc.) 802, a main memory 804, a static memory 806 (e.g., flash memory and a data storage device 808), which may communicate with each other via a bus 810. The computer processing device 802 may be provided by one or more general-purpose processing devices such as a microprocessor, central processing unit, or the like. In an illustrative example, computer processing device 802 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. The computer processing device 802 may also comprise one or more special-purpose processing devices such as an application specific integrated circuit (ASIC), a field programmable gate array (FPGA), a digital signal processor (DSP), network processor, or the like. The computer processing device 802 may be configured to execute the operations described herein, in accordance with one or more aspects of the present disclosure, for performing the operations and steps discussed herein.

The computing device 800 may further include a network interface device 812, which may communicate with a network 814. The data storage device 808 may include a machine-readable storage medium 816 on which may be stored one or more sets of instructions, e.g., instructions for carrying out the operations described herein, in accordance with one or more aspects of the present disclosure. Instructions 818 implementing a fraud detection module (e.g., fraud detection module 120 illustrated in FIG. 1) may also reside, completely or at least partially, within main memory 804 and/or within computer processing device 802 during execution thereof by the computing device 800, main memory 804 and computer processing device 802 also constituting computer-readable media. The instructions may further be transmitted or received over the network 814 via the network interface device 812.

While machine-readable storage medium 816 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer processing device, a computer, a system on a chip, or multiple ones, or combinations, of the foregoing. A computer processing device may include one or more processors which can include special purpose logic circuitry, e.g., an FPGA (field programmable gate array) or an ASIC (application specific integrated circuit), a central processing unit (CPU), a multi-core processor, etc. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative, procedural, or functional languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto optical disks, optical disks, or solid state drives. However, a computer need not have such devices. Moreover, a computer can be embedded in another device, e.g., a smart phone, a mobile audio or media player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Reference throughout this specification to “one embodiment” or “an embodiment” means that a particular feature, structure, or characteristic described in connection with the embodiments included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

What is claimed is:

1. A method comprising:
obtaining a plurality of signals purported to have been generated by respective ones of a plurality of client devices;
calculating a summary value for the plurality of signals indicating a measure of similarity between the plurality of signals and an expected distribution of signals;
determining, by a computer processing device, that the summary value represents a statistically significant deviation of the plurality of signals from the expected distribution of signals; and
labeling the plurality of signals as fraudulently generated based on the statistically significant deviation.

2. The method of claim 1, wherein the plurality of signals are purported to be a plurality of unique device identifications for the respective ones of the plurality of client devices.

3. The method of claim 2, further comprising:
determining that a unique device identification comprises an invalid character; and
labeling the unique device identification as fraudulently generated.

4. The method of claim 1, wherein the expected distribution of signals represents a known character distribution of a plurality of alphanumeric strings.

5. The method of claim 1, further comprising:
uploading data labeling the plurality of signals as fraudulent to a database to provide a historical collection of fraudulent signals.

6. The method of claim 1, wherein calculating the summary value comprises:
performing a chi-square goodness of fit test on the plurality of signals and the expected distribution of signals.

7. The method of claim 1, further comprising:
generating a fraud report of the fraudulent plurality of signals; and
sending the fraud report to one or more third-party publishers or partners.

8. The method of claim 1, wherein the summary value is a significance level calculated by performing a chi-square goodness of fit test.

9. The method of claim 1, wherein the plurality of signals are purported to be a plurality of timestamps associated with a plurality of clicks within an application, and wherein the expected distribution of signals represents an expected distribution of timestamps for a plurality of legitimate clicks within the application.

10. The method of claim 1, wherein calculating the summary value is associated with a batched fraud-detector test, and the method further comprises:
performing a real-time fraud-detection test comprising:
obtaining a stream of data comprising a plurality of signals, wherein each signal of the plurality of signals comprises a plurality of characters;
parsing each character to identify an invalid character, wherein the invalid character is not included in a set of accepted characters; and
labeling the signal associated with the invalid character as fraudulently generated.

11. A system, comprising:
one or more computer processing devices programmed to:
obtain a plurality of signals purported to have been generated by respective ones of a plurality of client devices;
calculate a summary value for the plurality of signals indicating a measure of similarity between the plurality of signals and an expected distribution of signals;
determine that the summary value represents a statistically significant deviation of the plurality of signals from the expected distribution of signals; and
label the plurality of signals as fraudulently generated based on the statistically significant deviation.

12. The system of claim 11, wherein the plurality of signals are purported to be a plurality of unique device identifications for the respective ones of the plurality of client devices.

13. The system of claim 12, wherein the one or more computer processing devices are further programmed to:
determine that a unique device identification comprises an invalid character; and
label the unique device identification as fraudulently generated.

14. The system of claim 11, wherein the expected distribution of signals represents a known character distribution of a plurality of alphanumeric strings.

15. The system of claim 11, to calculate the summary value, the one or more computer processing devices are further programmed to perform a Chi-Square Goodness of Fit test on the plurality of signals and the expected distribution of signals.

16. A non-transitory computer-readable medium having instructions stored thereon that, when executed by one or more computer processing devices, cause the one or more computer processing devices to:
obtain a plurality of signals purported to have been generated by respective ones of a plurality of client devices;
calculate a summary value for the plurality of signals indicating a measure of similarity between the plurality of signals and an expected distribution of signals;
determine that the summary value represents a statistically significant deviation of the plurality of signals from the expected distribution of signals; and
label the plurality of signals as fraudulently generated based on the statistically significant deviation.

17. The non-transitory computer readable storage medium of claim 16, wherein the plurality of signals are purported to be a plurality of unique device identifications the respective ones of the plurality of client devices.

18. The non-transitory computer readable storage medium of claim 17, wherein the instructions further cause the one or more computer processing devices to:
determine that a unique device identification comprises an invalid character; and
label the unique device identification as fraudulently generated.

19. The non-transitory computer readable storage medium of claim 16, wherein the expected distribution of signals represents a known character distribution of a plurality of alphanumeric strings.

20. The non-transitory computer readable storage medium of claim 16, wherein calculating the summary comprises performing a chi-square goodness of fit test on the plurality of signals and the expected distribution of signals.
